(19) United States
(12) Patent Application Publication
(10) Pub. No.: US 2016/0209593 A1
(43) Pub. Date: Jul. 21, 2016

(54) POLARIZATION-SPLIT WAVELENGTH FILTER

(71) Applicant: Jia Jiang, Kanata (CA)

(72) Inventor: Jia Jiang, Kanata (CA)

(21) Appl. No.: 14/597,928

(22) Filed: Jan. 15, 2015

(51) Int. Cl. G02B 6/27

(52) U.S. Cl. CPC G02B 6/2773

(57) ABSTRACT

A polarization-splitting and wavelength filter comprising an input waveguide for receiving an optical input with both a Transverse Electric (TE) polarization and a Transverse Magnetic (TM) polarizations. The polarization-splitting and wavelength filter includes a first ring/racetrack resonator disposed along the input waveguide wherein the first ring/racetrack resonator includes a first coupler for coupling the TE polarization of a first wavelength. The polarization-splitting and wavelength filter also includes a second ring/racetrack resonator disposed along the input waveguide, wherein the second ring/racetrack resonator includes a second coupler for coupling the TM polarization of a second wavelength.

### TECHNICAL FIELD

The present invention relates to optical telecommunications and, in particular, to polarization-spill wavelength filters based on ring/racetrack resonators.

### BACKGROUND

Optical waveguides, e.g. silicon photonic waveguides, have great potential as platforms for photonic integrated circuits (PIC) and are widely used in optical networks and for environmental sensing. However, geometric shapes of waveguide cores and anisotropy of materials can cause polarization mode dispersion (PMD) in optical waveguides, thereby increasing polarization dependence of optical waveguide components and deteriorating the performance of optical functional devices such as wavelength filters.

There is therefore a desire to build photonic integrated circuits with polarization diversity. Traditional designs of a polarization diversity circuit usually includes a polarization splitter to separate input light into Transverse Electric (TE) and Transverse Magnetic (TM) components for guiding these orthogonal, components through two separate waveguides. One such approach is to rotate one component 90 degrees by a first polarization rotator in one optical path, so that components in both waveguides are propagating in the same polarization mode and functional devices of one polarization can be used. After the functional processing, a second polarization rotator rotates one component so that both components are merged by a polarization combiner into an output fiber. Another approach uses two optical functional devices in respective polarization modes.

FIG. 1A presents a polarization diversity wavelength filter 100(a) according to the first approach. Referring to FIG. 1A, input light is separated into TE and TM modes by a polarization splitter 102, where one mode is rotated into the same polarization of the other mode by a first polarization rotator 104. After going through wavelength filters 106 in one polarization (e.g., TE wavelength filters), one component is rotated again by a second rotator 104, and merged with the other component by a polarization combiner 110 into an output fiber.

FIG. 1B presents a polarization diversity wavelength filter 100(b) according to the second approach. Referring to FIG. 1B, the input light is separated into TE and TM modes by the polarization splitter 102. After splitting the TE and TM modes, optical functions are performed by separate TE wavelength filter 106 and TM wavelength filter 108. The outputs are then merged by a polarization beam combiner 110.

### SUMMARY

The following presents a simplified summary of some aspects or embodiments of the invention in order to provide a basic understanding of the invention. This summary is not an extensive overview of the invention. It is not intended to identify key or critical elements of the invention or to delineate the scope of the invention. Its sole purpose is to present some embodiments of the invention in a simplified form as a prelude to the more detailed description that is presented later.

In general, the present disclosure relates to a polarization-splitting wavelength filter that includes two ring/racetrack resonators having couplers for coupling the TE and TM polarizations.

One inventive aspect of the disclosure is a polarization-splitting wavelength filter comprising an input waveguide for receiving an optical input with both a Transverse Electric (TE) polarization and a Transverse Magnetic (TM) polarization, a first ring/racetrack resonator disposed along the input waveguide wherein the first ring/racetrack resonator includes a first coupler for coupling the TE polarization of a first wavelength and a second ring/racetrack resonator disposed along the input waveguide, wherein, the second ring/racetrack resonator includes a second coupler for coupling the TM polarization of a second wavelength.

Another inventive aspect of the disclosure is a method of performing polarization-splitting and wavelength filtering. The method entails receiving an optical Input via an input waveguide, the optical input having both a TE polarization and a TM polarization, coupling the TE polarization of a first wavelength into a first ring/racetrack resonator, and coupling the TM polarization of a second wavelength into a second ring/racetrack resonator.

### BRIEF DESCRIPTION OF THE DRAWINGS

These and other features of the disclosure will become more apparent from the description in which reference is made to the following appended drawings.

FIG. 1A illustrates a conventional polarization diversity circuit.

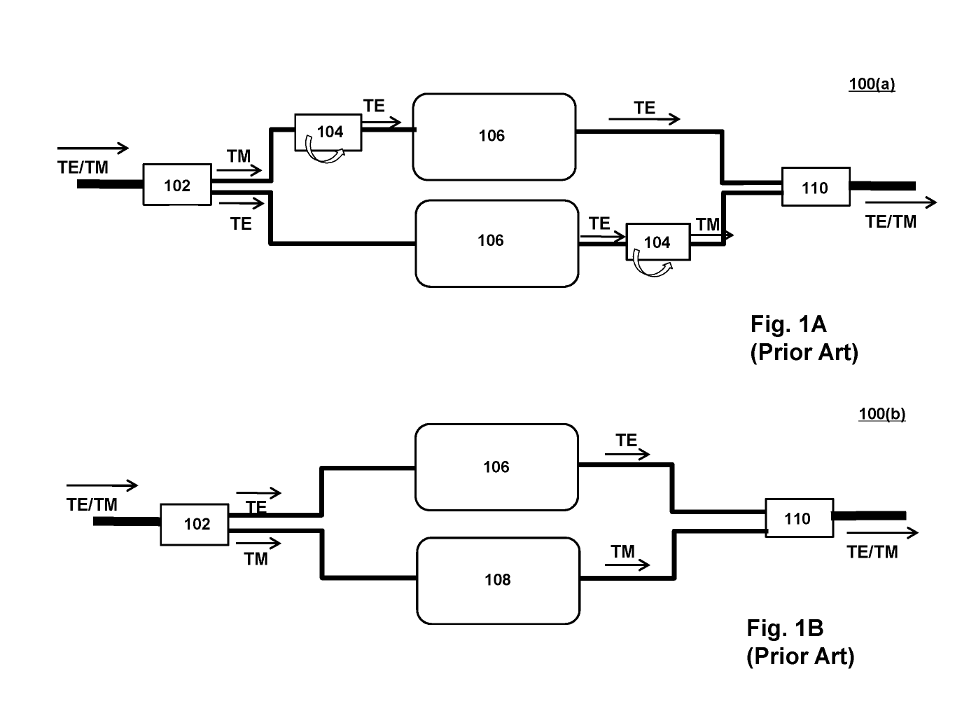

FIG. 1B illustrates another conventional polarization diversity circuit.

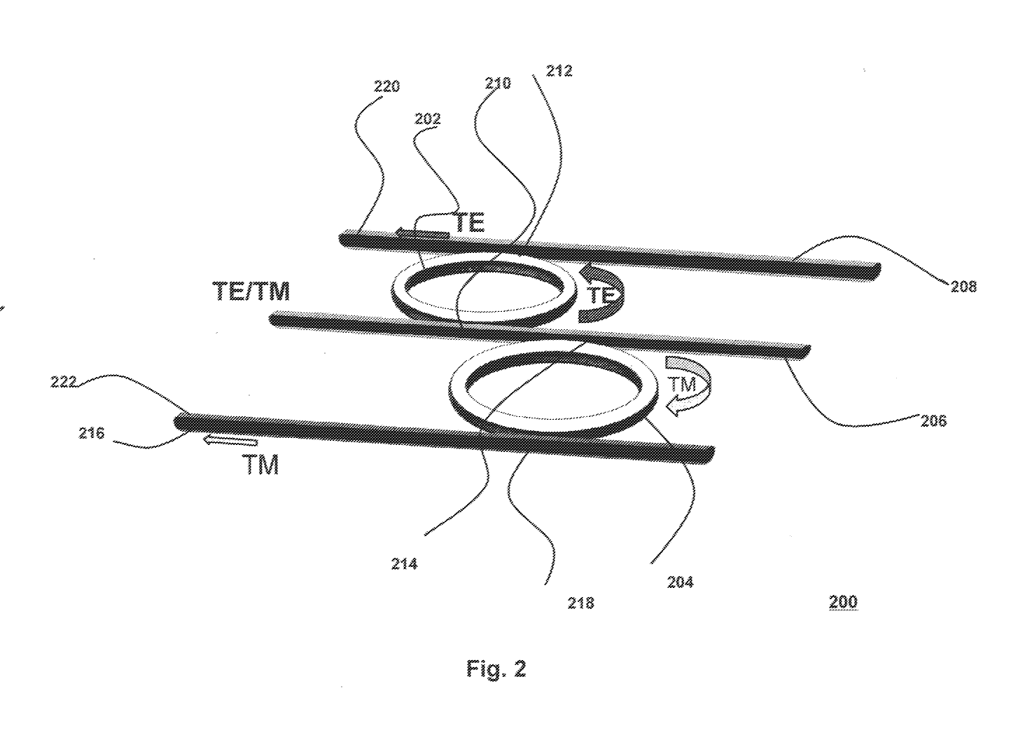

FIG. 2 illustrates a schematic layout of a polarization-split wavelength filter, according to one embodiment of the present invention.

FIG. 3 illustrates a TE/TM split wavelength filter, according to one embodiment of the present invention.

FIG. 4 illustrates a polarization diversity wavelength filter, according to one embodiment of the present invention.

FIG. 5 illustrates the optical propagation of two eigenmodes for a directional coupler for TE polarization and for TM polarization.

FIGS. 6A and 6B depict simulation results of TE and TM propagation through a directional coupler which is adapted to perform the function of a polarization splitter, according to one embodiment of the present invention.

FIGS. 7A and 7B depict simulation results of TE and TM propagation through a racetrack resonator with a directional coupler designed for TM polarization splitting, according to one embodiment of the present invention.

FIG. 8A depicts an example of a polarization split wavelength filter with two racetracks, according to one embodiment of the present invention.

FIG. 8B and FIG. 8C illustrate the corresponding simulation results of the optical field where TE and TM polarizations are coupled out in different racetracks.

FIG. 9 illustrates a polarization split wavelength filter, according to one embodiment of the present invention, where a separation gap of the directional coupler is used to control the TE and TM polarizations;

FIG. 10 illustrates a polarization split wavelength, filter, according to one embodiment of the present invention, where a coupling length of the directional coupler is used to control the TE and TM polarizations;

FIG. 11 presents a flowchart of building a polarization-splitting and wavelength filter according to an embodiment of the present invention.

FIG. 12 presents a flowchart for building one ring/racetrack resonator for the polarization-split wavelength filter according to m embodiment of the present invention.

### DETAILED DESCRIPTION

The following detailed description contains, for the purposes of explanation, numerous specific embodiments, implementations, examples and details in order in provide a thorough understanding of the invention. It is apparent, however, that the embodiments may be practiced without these specific details or with an equivalent arrangement. In other instances, some well-known structures and devices are shown in block diagram form in order to avoid unnecessarily obscuring the embodiments of the invention. The description should in no way be limited to the illustrative implementations, drawings, and techniques illustrated below, including the exemplary designs and implementations illustrated and described herein, but may be modified within the scope of the appended claims along with their fell scope of equivalents.

Various embodiments of the present invention are presented in this disclosure. These embodiments relate to a polarization diversity wavelength filter that does not require any separate polarization splitter and/or rotator. In the various embodiments disclosed in this application, the polarization-split wavelength filler employs two or more ring/racetrack resonators.

In the following description, the term ring/racetrack resonator is used in a broader sense to refer to any looped resonator and includes a looped optical waveguide and a coupling mechanism to access the loop. A ring resonator may in a narrower sense refer to a resonator of a circular, elliptical or elongated shape, whereas a racetrack resonator refers to a resonator where the shape is elongated with at least one straight section (typically along the coupling section). While specific embodiments may be described or illustrated with certain specific shapes, it should be understood that loops of other shapes (or other resonator shapes) may be used to achieve the same or substantially similar result.

In a ring/racetrack resonator, light is coupled into the ring/racetrack by a coupling mechanism such as, for example, a directional coupler. In the disclosed embodiments, a polarization-split wavelength filter includes two or more ring/racetrack resonators wherein the coupling mechanism of each ring/racetrack resonator performs functions of both coupling and polarization separation. Accordingly, the polarization-split wavelength filter can be implemented as a single optical device or optical apparatus without the need for any additional polarization splitter and/or rotator.

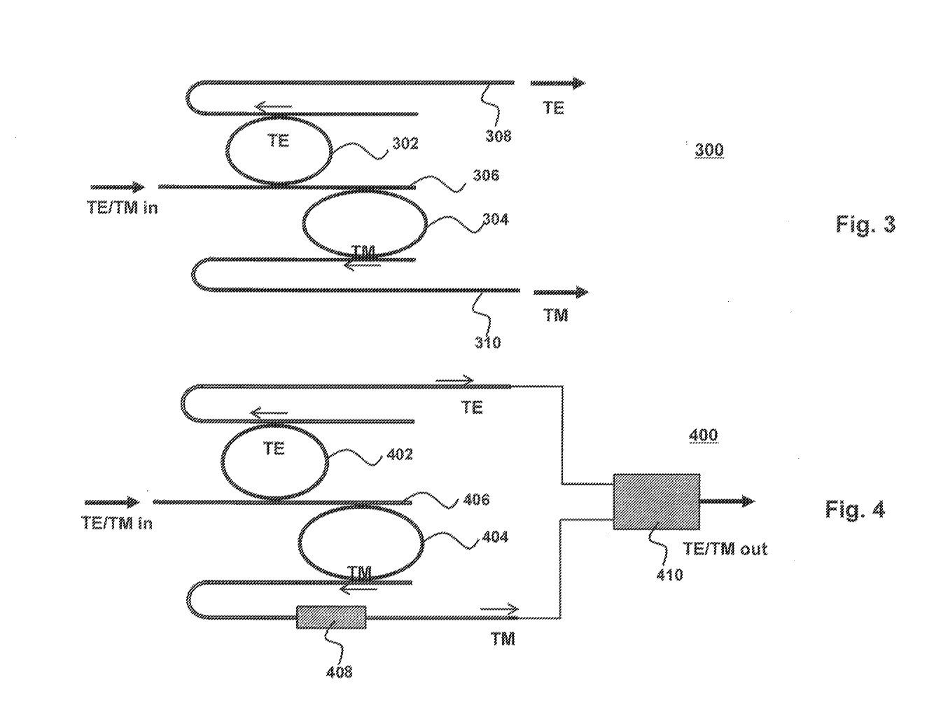

In the embodiment illustrated by way of example in FIG. 2, a polarization-split wavelength filter 200 includes two racetracks, namely a first racetrack 202 and a second racetrack 204, that are disposed along a straight waveguide 206 to constitute the resonators for respective TE and TM polarizations. The two racetracks 202, 204 are disposed at different locations on the straight waveguide 206, which may be on separate sides of the waveguide 206 or, alternatively, on the same side of the waveguide 206. While in the embodiment illustrated in FIG. 2, the first racetrack 202 is disposed upstream of the second racetrack 204 along the input waveguide 206. The second racetrack 204 may alternatively be disposed upstream of the first racetrack 202 along the input waveguide 206.

The straight waveguide 206 receives an optical input with, both TE and TM polarizations and functions as an optical bus line to the resonators 202, 204.

The flat waveguide portion of the racetrack 202 (or the portion of the racetrack 202 that is adjacent the waveguide 206) and the bus waveguide 206 constitute a first coupler 210, allowing light of a specific wavelength to couple into the racetrack 202, and to further drop out from a second straight waveguide 208 which is located at the other side of the racetrack 202. lire second straight waveguide 208 and the other side of the racetrack 202 constitute a second coupler 212 of the racetrack 202. Each coupler 210, 212 in the first racetrack 202 is designed for TE polarization, which allows only light m the TE polarization to couple into the racetrack 202, and to transmit to drop port 220.

The functionality of the TM polarization splitting and wavelength filtering is implemented by a second racetrack 204, which is disposed at a different location on the same bus waveguide 206. The flat waveguide portion of the racetrack 204 (or the portion of the racetrack 204 that is adjacent the waveguide 206) and the bus waveguide 206 constitute a first coupler 214 of the racetrack 204, allowing the light in a specific wavelength to couple into the racetrack 204, and to further drop out from a third straight waveguide 216 which is located at the other side of the racetrack 204. The third straight waveguide 216 and the other side of the racetrack 204 constitutes a second coupler 218 of the racetrack 204. Each coupler 214, 218 in the second racetrack 204 is designed for light propagation in the TM polarization, which permits only light in the TM polarization to couple into the racetrack 204, and to drop out from the third straight waveguide 216 via the TM mode drop port 222. The wavelengths coupled by the first ring/racetrack resonator 202 and the second ring/racetrack resonator 204 may be the same or different, depending on different applications.

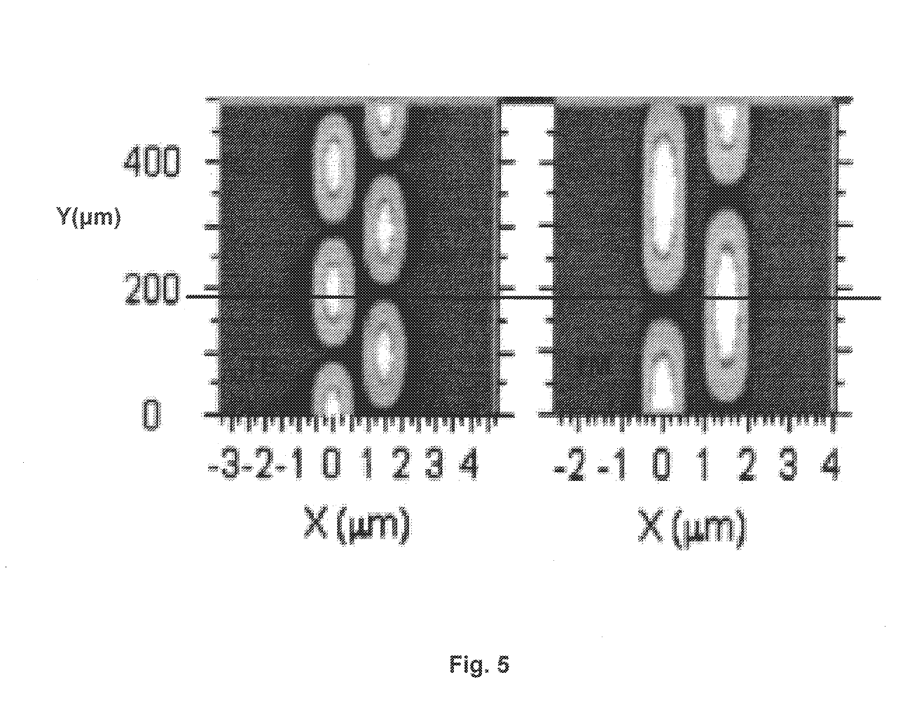

In the embodiment illustrated by way of example in FIG. 3, a TE/TM split wavelength filter 300 includes two ring resonators, namely a first ring resonator 302 and a second ring resonator 304. Light is input into a straight waveguide 306. Light that is polarized in the TE polarization and propagating at a first wavelength is filtered out by the first ring resonator 302 and dropped out at a TE port 308. Light that is polarized In the TM polarization and propagating at a second wavelength is filtered out by the second ring resonator 304 and dropped out at a TM port 310. The wavelengths coupled by the first ring/racetrack resonator 302 and the second ring/racetrack resonator 304 may be the same or different, depending on different applications. Compared to the conventional diversity wavelength filters which require a separate polarization splitter, combiner and in some cases rotators, the polarization-splitting wavelength filter of illustrated in FIG. 3 enables the TE and TM polarization modes to be filtered into different drop ports through two separate racetrack resonators. No additional polarization splitter or rotators are required in this embodiment.

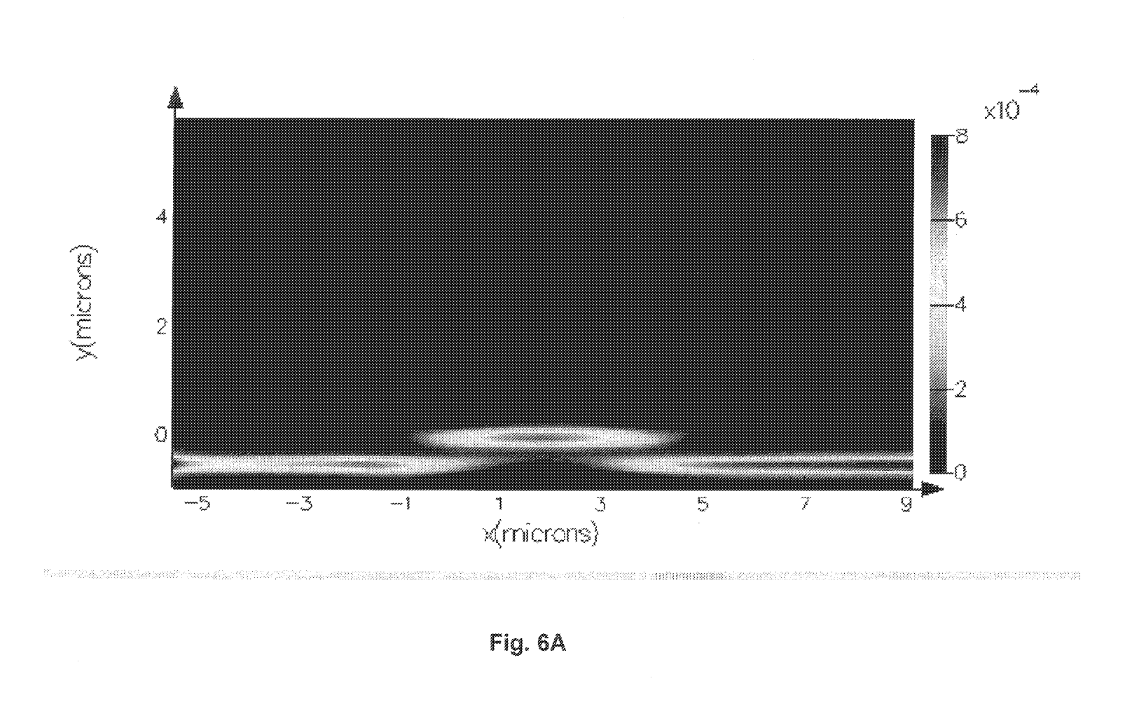

In the embodiment illustrated by way of example in FIG. 4, a polarization diversity wavelength filter makes use of two ring resonators, namely a first ring resonator 402 and a second ring resonator 404. Light is input into a straight waveguide 406. Light of a specific wavelength is filtered out in the TE polarization through the first ring resonator 402 and in the TM polarization through the second ring resonator 404. The TM polarization light is delayed by delay lines 408. A polarization combiner 410 combines both the TM light and the TE light for output.

In the embodiments depicted in FIGS. 2-3, the TE and TM polarization modes may be filtered for different wavelengths or the same wavelength. In the embodiment depicted in FIG. 4, the TE and TM polarization modes axe usually filtered for the same wavelength. In either scenario, the polarization-split wavelength filter performs both the functions of polarization splitting and the wavelength filtration in the same device, which simplifies design, fabrication and manufacturing which, in turn, lowers the cost. Since wavelength filters are widely applied in Dense Wavelength Division Multiplexing (DWDM) systems, the cost of such systems can be significantly reduced. In other words, in these embodiments, polarization dependence of a coupling mechanism is utilized to realize the polarization-split wavelength filter, which does not require any additional polarization splitter to achieve the wavelength filter polarization diversity. The coupler design, e.g. directional coupler design, splits the TE and TM polarizations with lower optical loss. The device can be used for an optical polarized transmitter and receiver. The compact structure, which means that the chip area is utilized with high efficiency, can significantly decrease the PIC cost. This polarization-split wavelength filter has many applications in optical networking and environmental sensing.

Both the ring/racetrack structure and the coupling mechanism are dependent on PMD, which would influence significantly the coupling wavelength and coupling ratio. PMD may be caused by the geometric shape of the waveguide geometric shape, stress imposed on the waveguide and/or the anisotropy of materials used to make the waveguide. For silicon nano-wire devices, the PMD is particularly due to its non-square cross-sectional waveguide structure. In at least some embodiments, each ring/racetrack resonator is designed to filter a specific wavelength in one polarization.

In at least some embodiments, each ring/racetrack resonator is designed to filter a specific wavelength λᵣₑₛ designed so that when the light waves in the loop of the ring/racetrack build up a round trip phase shift that equals an integer times 2π, the waves interfere constructively and the cavity is in resonance. λᵣₑₛ can be generally represented by the following equation:

$${λ}_{res} = \frac{{n}_{eff} L}{m} , m = 1 , 2 , 3 … \qquad ( 1 )$$

where L is the length of the ring or racetrack and n_{eff} is the effective index. The spacing between adjacent resonances, known as the free spectral range (FSR) is represented as follows:

$$F S R = \frac{{λ}_{res}^{2}}{{n}_{eff}} \times L \qquad ( 2 )$$

In a ring/racetrack resonator, n_{eff} is usually Influenced by the retractive index of the waveguide cladding and is dependent on the material of the waveguide, shape of the ring/racetrack, and also the polarization mode. Accordingly, to filter the same wavelength, the TM and TE ring/racetracks are usually built with different lengths.

In at least some embodiments, each coupler in the ring/racetrack resonators is also designed to perform the function of a polarization splitter, so that one polarization travels through while the other polarization couples into the ring/racetrack.

The separation of the TE and TM modes may make use of the difference of propagation constants between the two modes caused by birefringence. In the case of a directional coupler, the coupling length Lx, or the cross-over length where power is localized in the coupling waveguide, is dependent on the polarization and can be used to separate the two modes.

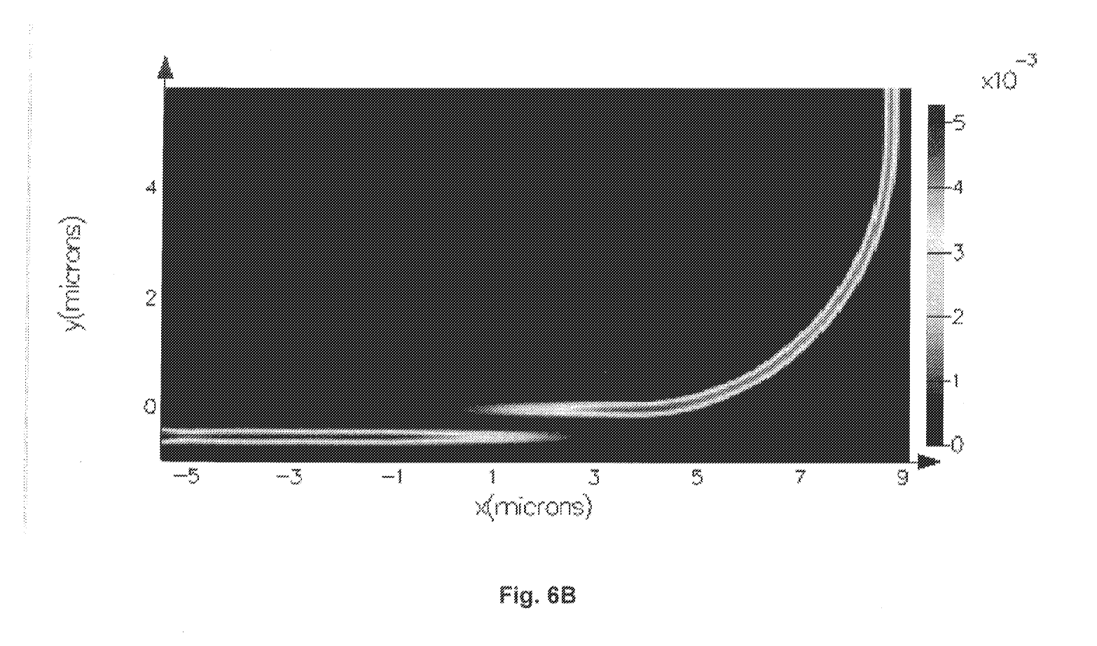

FIG. 5 illustrates the optical propagation of two eigenmodes for a directional coupler for the TE polarization and for the TM polarization, respectively. As shown in FIG. 5, both the coupling length (with respect to the Y-axis) and the gap separation between, the waveguides (with respect to the X-axis) are different for the TE and TM modes. By selecting the appropriate coupling length and/or gap separation, one polarization can be coupled out with a high coupling ratio while the other polarization travels through with a low coupling ratio.

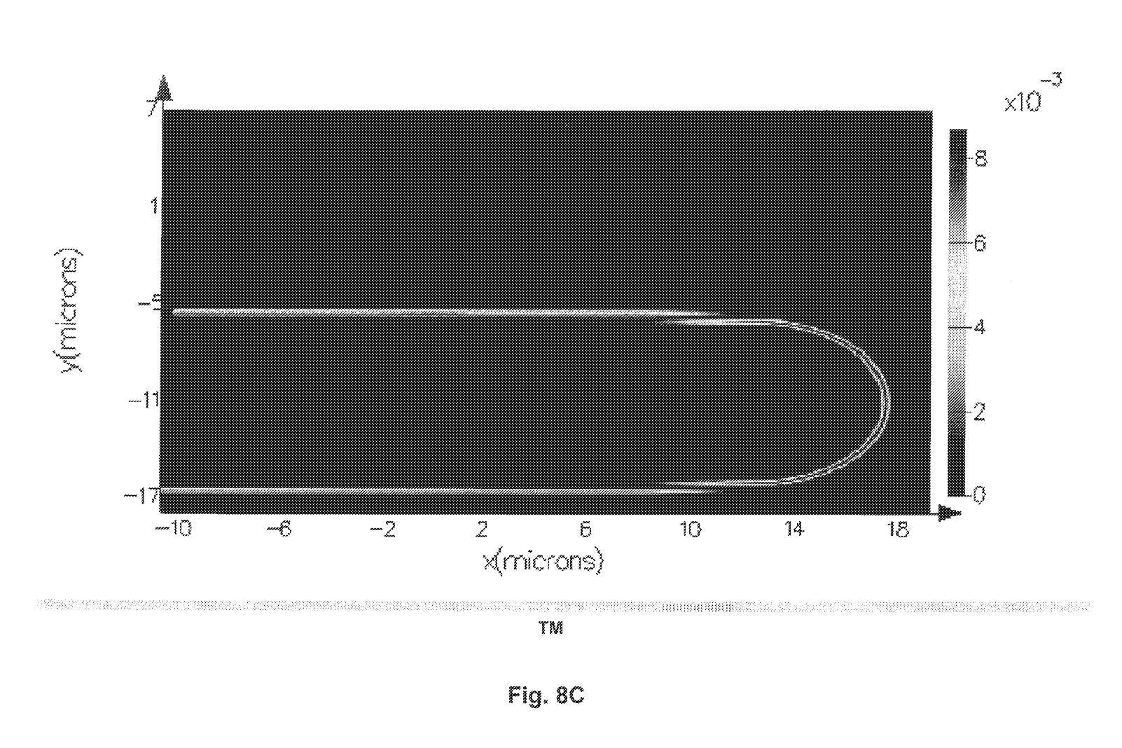

In the embodiment depicted by way of example in FIG. 9, a polarization-split wavelength filter 500 has gap separations G₁, G₂ for the directional couplers 508, 510 between resonators 502, 504 and input waveguide 506 are designed to control the TE and TM polarization splitting. As illustrated in this particular embodiment, the gap separation G₁ for the TE resonator 502 is larger than the gap separation G₂ for the TM resonator 504.

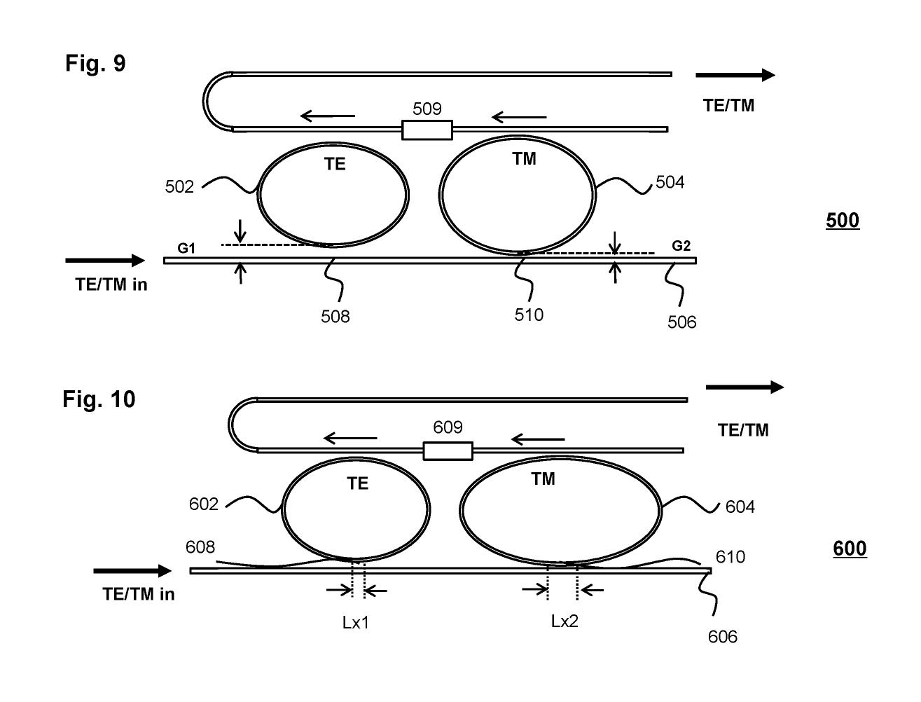

In the embodiment depicted by way of example in FIG. 10, a polarization-split wavelength filter 600 has two different coupling lengths Lx₁, Lx₂ for the two directional couplers 608, 610 that are disposed between resonators 602, 604 and an input waveguide 606. The coupling lengths are designed to control the splitting of the TE and TM polarizations. As illustrated In this particular embodiment, the coupling length Lx₁ for the TE resonator 602 is smaller than the coupling length Lx₂ for the TM resonator 604.

In the embodiments depicted In both FIG. 9 and FIG. 10, the TE and TM resonators 502, 504, 602, 604 are disposed on the same side of the respective bus waveguides 506, 606. The TM component is delayed by delay lines 508, 608 and combined with the TE component for TE/TM combined light.

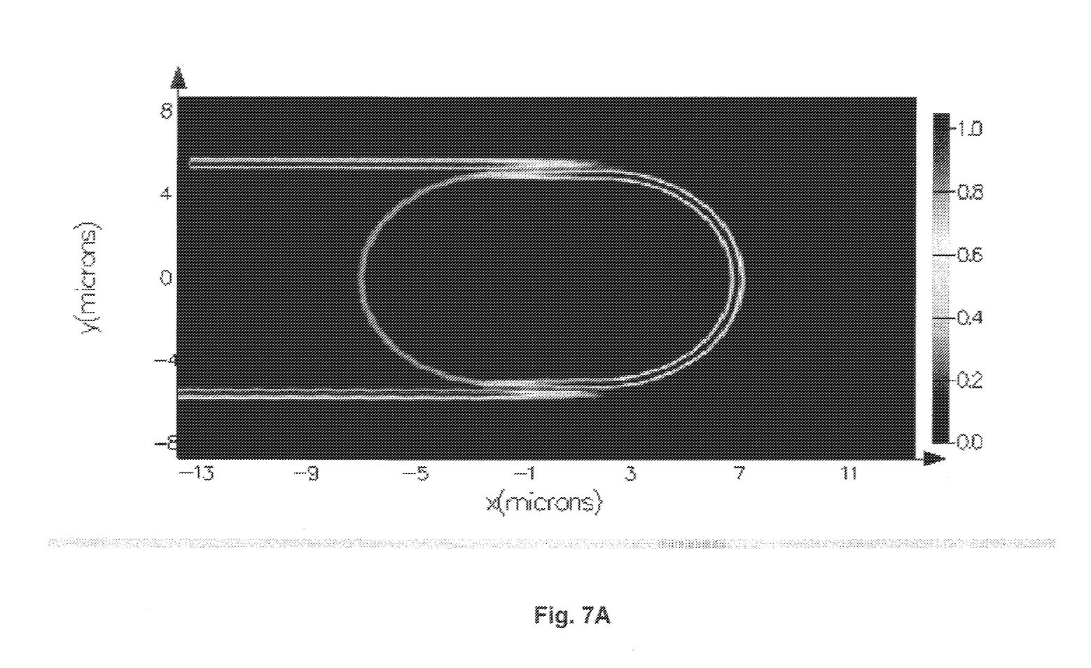

FIG. 6 provides simulation results of TE and TM propagation through a directional coupler that is configured to perform the function of a polarization splitter. FIG. 6A illustrates that light of one polarization propagates through the directional coupler, and continue to propagate in the through waveguide without propagation in the crossing waveguide. FIG. 6B shows light of the other polarization being coupled into and propagate continuously in the crossing waveguide.

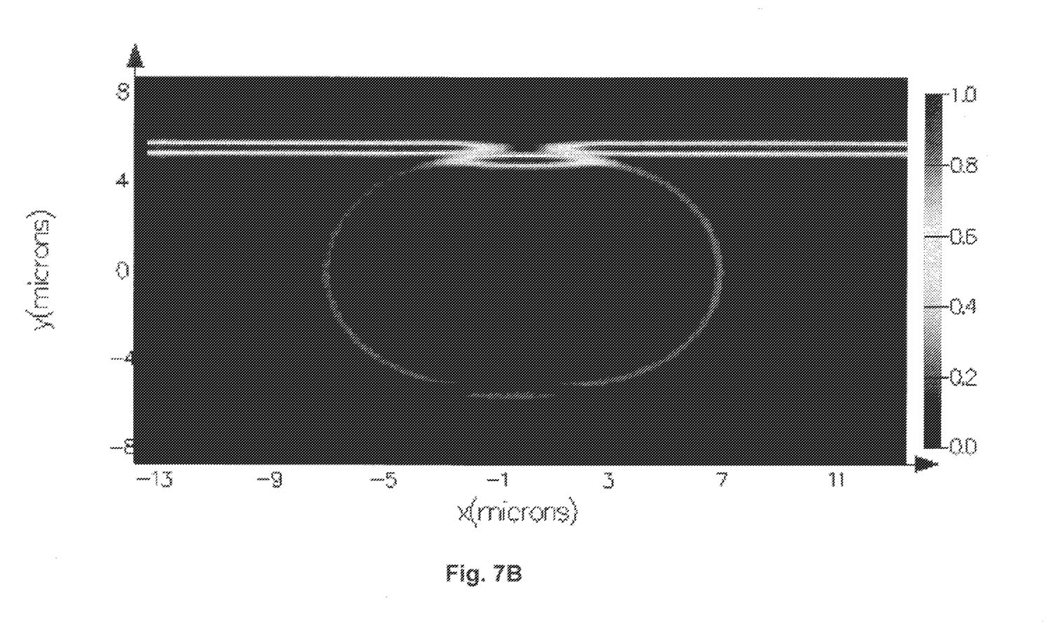

FIGS. 7A and 7B provide simulation results of TE and TM propagation through a racetrack resonator with a directional coupler designed for TM polarization splitting. As shown in FIG. 7A, TM light is coupled into the racetrack and is output through the other side of the resonator. FIG. 7B shows that TE light travels through the racetrack without being coupled into the resonator. While the simulation is run for an exemplary wavelength of 1550 nm, it should be understood that the ring/racetrack resonators can be designed to operate at other wavelengths.

As illustrated by FIGS. 6, 7A and 7B, light in one polarization should be coupled into the ring/racetrack within the designed coupling length with as near to 100% coupling coefficient as possible while most light in the other polarization, should remain in the input waveguide without coupling. However, since the other polarization light also has a mode intensity distribution around the coupling distance, the tail of the mode distribution may overlap with the other mode. A small amount of the other polarization light may start coupling into the ring/racetrack. The design attempts to minimize the other polarization light coupling, i.e. by designing towards a coupling coefficient of 0.

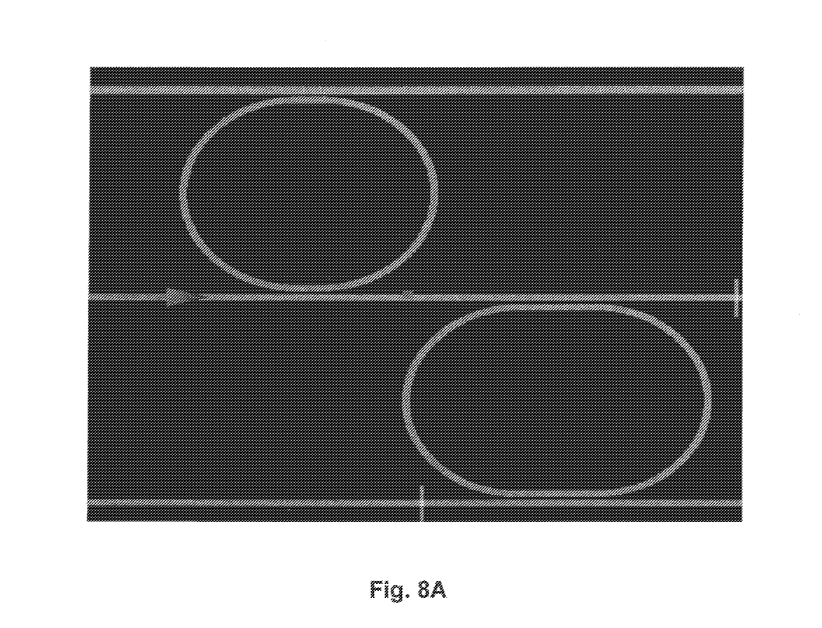

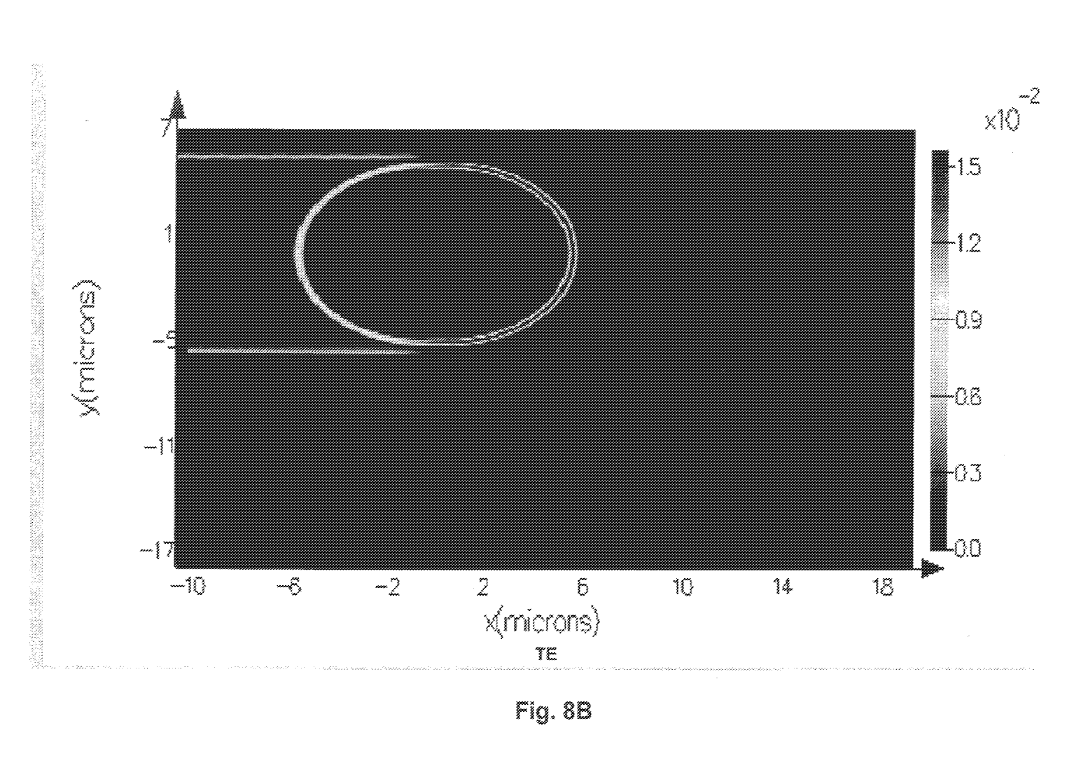

FIG. 8A provides an example of a polarization-split wavelength filter with two racetracks. FIG. 8B and FIG. 8C illustrate the corresponding simulation results of the optical field where TE and TM polarizations are coupled onto different racetracks. More specifically, FIG. 8B shows TE light that is coupled onto the first racetrack and FIG. 8C shows TM light that is coupled onto the second racetrack.

While various embodiments refer to directional couplers for coupling light from the input waveguide to the ring/racetrack resonators, it should be understood that other couplers may be used, such as multi-mode interferometers (MMI), MMI-based Y-branch couplers, or other polarization-sensitive couplers or polarization-insensitive couplers. For example, in the case of an MMI coupler, the MMI coupler may be designed to split TE and TM propagation modes based on the self-image lengths of TE and TM which are different in the MMI slab area.

In other implementations, a polarization-split wavelength filter or a polarization diversity wavelength filter can be built using more than two ring/racetrack resonators, where each ring/racetrack resonator is used to couple and filter one particular wavelength of one polarization. Depending on different applications, the rings/racetracks can be placed at various positions along the input/output waveguide and may or may not come in pairs. It should be understood that depending on specific applications, an optical device with any number of ring/racetrack resonators and that work with different wavelengths can be implemented without any separate polarization splitter(s).

Various optical materials cm be used to build the polarization diversity wavelength filter or the polarization-split wavelength filter such as, for example, silicon, silica-on-silicon, InP, SiON, Si₃N₄, polymer or other suitable optical materials.

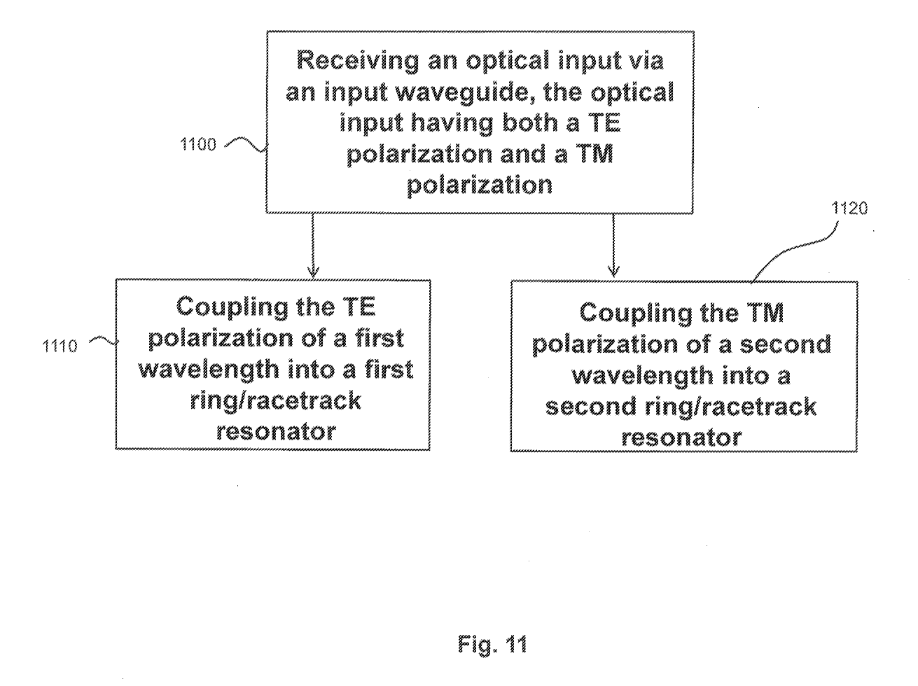

FIG. 11 presents a flowchart outlining a method of performing polarization splitting and wavelength filtration. The method includes steps, acts or operations of receiving, at step 1100, an optical input via an input waveguide, the optical input having both a TE polarization and a TM polarization. The method includes a step 1110 of coupling the TE polarization of a first wavelength into a first ring/racetrack resonator and a step 1120 of coupling the TM polarization of a second wavelength into a second ring/racetrack resonator. The coupling of the TM and the coupling of TE occur substantially simultaneously. This method may be performed with first wavelength and the second wavelength being the same or different.

The first ring/racetrack resonator may be designed by determining a racetrack/ring length for the first ring/racetrack resonator based on the first wavelength. Likewise, the second ring/racetrack resonator may be designed by determining a racetrack/ring length for the second ring/racetrack resonator based on the second wavelength.

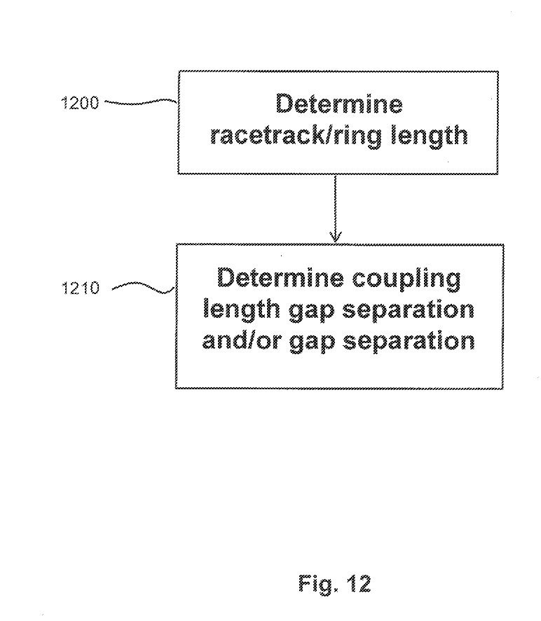

FIG. 12 presents a flowchart outlining a method of designing the ring/racetrack resonator for the polarization-split wavelength filter. For each ring/racetrack resonator to be built in the filter, depending on the resonance wavelength, racetrack/ring length L is determined at step 1200, based on equation (1). With respect to a same wavelength, the ring/racetrack is usually built with different lengths for TE polarization and TM polarization. At step 1210, the coupling length Lx and/or gap separation G is then determined depending on-which polarization to couple out, which is a function of wavelength and an effective index for a particular polarization. In other words, the method may include designing the first coupler by determining at least one of a coupling length and a gap separation to couple the TE polarization of the first wavelength, and designing the second coupler by determining at least one of a coupling length and a gap separation to couple the TM polarization of the second wavelength. Coupling may be performed by a directional coupler, MMI coupler or MMI-based Y-branch coupler.

It is to be understood that the singular forms “a”, “an” and “the” include plural referents unless the context clearly dictates otherwise. Thus, for example, reference to “a device” includes reference to one or more of such devices, i.e. that there is at least one device. The terms “comprising”, “having”, “including” and “containing” are to be construed as open-ended terms (i.e., meaning “including, but not limited to,”) unless otherwise noted. All methods described herein can be performed in any suitable order unless otherwise indicated herein or otherwise clearly contradicted by context. The use of examples or exemplary language (e.g. “such as”) is intended merely to better illustrate or describe embodiments of the invention and is not intended to limit the scope of the invention unless otherwise claimed.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

1. A polarization-splitting wavelength filter comprising:
an input waveguide for receiving an optical input with both a Transverse Electric (TE) polarization and a Transverse Magnetic (TM) polarization;
a first ring/racetrack resonator disposed along the input waveguide wherein the first ring/racetrack resonator includes a first coupler for coupling TE-polarized light at a first wavelength; and
a second ring/racetrack resonator disposed along the input waveguide, wherein the second ring/racetrack resonator includes a second coupler for coupling TM-polarized light at a second wavelength.

2. The polarization-splitting wavelength filter according to claim 1, wherein the first wavelength is equal to the second wavelength.

3. The polarization-splitting wavelength filter according to claim 1, wherein the first wavelength and the second wavelength are different.

4. The polarization-splitting wavelength filter according to claim 1, further comprising an output waveguide for receiving the TE-polarized light and the TM-polarized light, wherein the first ring/racetrack resonator and the second ring/racetrack resonator are disposed on a same side of the input waveguide.

5. The polarization-splitting wavelength filter according to claim 4, further comprising a delay line to delay the TM-polarized light.

6. The polarization-splitting wavelength filter according to claim 1, wherein the first ring/racetrack resonator and the second ring/racetrack resonator are provided on separate sides of the input waveguide, and the TE-polarized light and the TM-polarized light are received by separate output waveguides.

7. The polarization-splitting wavelength filter according to claim 6, further comprising a delay line in one of the output waveguides to delay the TM-polarized light polarization.

8. The polarization-splitting wavelength filter according to claim 7, further comprising a polarization combiner connected to the output waveguides for combining the TE-polarized light and the TM-polarized light.

9. The polarization-splitting wavelength filter according to claim 1, wherein at least one of the first coupler and the second coupler is a directional coupler.

10. The polarization-splitting wavelength filter according to claim 1, wherein at least one of the first coupler and the second coupler is a MM I coupler.

11. The polarization-splitting wavelength filter according to claim 1, wherein at least one of the first coupler and the second coupler is a MMI-based Y-branch coupler.

12. The polarization-splitting wavelength filter according to claim 1, wherein a racetrack/ring length of the first ring/racetrack resonator is adapted to resonate the TE-polarized light having at the first wavelength.

13. The polarization-splitting wavelength filter according to claim 1, wherein a racetrack/ring length of the second ring/racetrack resonator is adapted to resonate the TM-polarized light at the second wavelength.

14. The polarization-splitting wavelength filter according to claim 1, wherein at least one of a coupling length and a gap separation is adapted for the first coupler to couple the TE-polarized light at the first wavelength.

15. The polarization-splitting wavelength filter according to claim 1, wherein at least one of a coupling length and a gap separation is adapted for the second coupler to couple the TM-polarized light at the second wavelength.

16. The polarization-splitting wavelength filter according to claim 1, wherein the first ring/racetrack resonator is disposed upstream of the second ring/racetrack resonator along the input waveguide.

17. The polarization-splitting wavelength filter according to claim 1, wherein the second ring/racetrack resonator is disposed upstream of the first ring/racetrack resonator along the input waveguide.

18. The polarization-splitting wavelength filter according to claim 1, further comprising one or more ring/racetrack resonators, each including a coupler for coupling one polarization of one wavelength.

19. The polarization-splitting wavelength filter according to claim 1, wherein each of the input waveguide, the first ring/racetrack resonator, and the second ring/racetrack resonator is built with silicon, silica-on-silicon, InP, SiON, Si3N4, or polymer.

20. A method of performing polarization-splitting and wavelength filtering, the method comprising:
receiving an optical input via an input waveguide, the optical input having both a TE polarization and a TM polarization;
coupling TE-polarized light at a first wavelength into a first ring/racetrack resonator; and
coupling TM-polarized light at a second wavelength into a second ring/racetrack resonator.

21. The method according to claim 20 wherein the first wavelength and the second wavelength are the same.

22. The method according to claim 20 wherein the first wavelength and the second wavelength are different.

23. The method according to claim 20 wherein coupling the TE-polarized light and coupling the TM-polarized light are each performed by a directional coupler.

24. The method according to claim 20 wherein coupling the TE-polarized light and coupling the TM-polarized light are each performed by an MMI coupler or by an MMI-based Y-branch coupler.
